(19) United States
(12) Patent Application Publication
(10) Pub. No.: US 2006/0229920 A1
(43) Pub. Date: Oct. 12, 2006

(54) Method of allocating seats to customers in a computer reservation system

(75) Inventors: Olivier Favorel, Nice (FR); David Hassan, Nice (FR); Emilio Vizzari, Nice (FR)

Correspondence Address: YOUNG & THOMPSON, 745 SOUTH 23RD STREET, 2ND FLOOR, ARLINGTON, VA, 22202, US

(73) Assignee: AMADEUS S.A.S., BIOT (FR)

(21) Appl. No.: 10/520,115

(22) PCT Filed: Jun. 13, 2003
(86) PCT No.: PCT/FR03/50011

§ 371 Date: Jan. 3, 2005

Related U.S. Application Data
(60) Provisional application No. 60/444,693, filed on Feb. 4, 2003.

(30) Foreign Application Priority Data
Jul. 2, 2002 (FR) 0208243

(51) Int. Cl. G06Q 10/00

(52) U.S. Cl. 705/5

(57) ABSTRACT

A process of allocating seats to customers usable with a computerized reservation system. This process includes the following allocation steps: assigning, in a database, to each customer, data relating to criteria of placement; determination of a value of satisfaction of the customer for a seat as a function of its adequacy with respect to the placement criteria, assigning, in a database, to each customer, a level of priority, allocating, to each customer, by decreasing order of level of priority, the available seat having the maximum satisfaction value. Particular application to the reservation of seats in the field of aircraft transport.

The present invention relates to a process of allocation of seats to customers usable with a computer reservation system.

This process will find particular application in the field of aerial transport.

In this field, there are frequently used reservation systems using computer means so as to control the reservation of seats in the planning of flights or moreover the tariffs associated with the transport services.

Up until now, the placement of persons onboard the aircraft takes place by a manual assignment by an employee. The criteria essentially used by the employee to carry out displacement are the distribution of weight within the aircraft and taking into account on a case by case basis, the desires of the passengers.

As a result of the development of aerial transport and associated services, as well as the stiff competition in this economic sector, there is at present the need for increased adaptability to the desires of the customers as well as the need for rationalizing the steps of placement of persons onboard the aircraft.

The present invention permits responding to these requirements and provides, for this purpose, a process for the allocation of seats according to different parameters.

A first advantage of this process is to take account of different levels of priority of the customers. It can thus be adapted to the presence of several different classes of aerial service such as business class or again economy class.

Another advantage of the invention is that it takes account of different criteria of choice so as better to respond to the preferences expressed by the customers. In this regard, different criteria could be selected and among others the proximity of the passenger to other persons, the seats or the regions of the aircraft in which the person desires to be placed, the assignment to a multi-stop flight (with connections), the distribution of the weight or of the particular comfort services such as preservation of free seats about the passenger.

Contrary to the manual mode of placement used at present, the process proposed here has the advantage of being revisable with each change of situation and particularly in the case of cancellation of the reservation of a new reservation.

To achieve these advantages, the present invention uses different computer means. such as a database permitting exploiting different criteria concurrent to the determination of a plan of allocation of the seats to the customers.

Other objects and advantages will become apparent from the description which follows, of a preferred embodiment of the invention, which is however not limiting.

In this regard, the description which follows is applicable to a reservation of seats for aircraft travel, onboard an airplane. However, this application is not limiting and the invention could be used for any other technical sector in which a reservation of places is necessary.

The invention relates to a process for the allocation of seats to customers, usable with a computerized reservation system and comprising the following allocation steps:
assignment, in a database, to each customer, of data relating to criteria of placement;
determination of a value of satisfaction of the customer for a seat as a function of the correspondence to the placement criteria,
assignment, in a database, to each customer, of a level of priority,
allocation by an allocation server, to each customer, by decreasing order of level of priority, of the available seat having the maximum satisfaction value.

This process could be subject to the following preferred modifications:
the steps of allocation are reiterated for each new reservation or cancellation of a seat,
if the available seats are all taken, placement of the remaining customers on the waiting list,
assigning to each seat at least one attribute of inclusion in the group of available seats, for the definition of the seats available for allocation,
excluding from the group of available seats the seats whose reservation is confirmed by the customer,
for the customers whose seat has a confirmed reservation, carrying out a search procedure for the best seat by the allocation steps,
the criteria of placement comprise data as to the zone or location of seats desired by the customer,
the placement criteria comprise a criterion of adjacency of the customer with at least one other customer,
assigning to each placement criterion an attribute defining it either as obligatory or as preferred,
assigning to each placement criterion an attribute of weight for the determination of the values of satisfaction.

Within the scope of the invention, there are distinguished seats for which a reservation has already been confirmed and which are considered as not available in the future, seats for which the reservation is not yet confirmed, which is to say not finally. These latter seats are included in the present allocation procedure. Upon each repetition of the process according to the invention, these available seats can be reallocated according to the development of the criteria used by the process of the invention.

In practice, if a passenger has confirmed his reservation, the seat allotted to him is thus considered as unavailable. This is particularly the case when he has already checked in and has a boarding pass with a published seat number. In other cases, the seats are considered as available.

In the database used by the present invention, the character of availability or not of the seats will be defined at least by an attribute of inclusion in the group of available seats. If this attribute is positive, the seat is included in the quantity of seats available for the computation of allocation. In the contrary case, the seat is excluded from the allocation process.

More precisely, the attribute of inclusion will be a function of the fact that the reservation is confirmed by the customer or not. This being the case, if a customer has a seat whose reservation is confirmed (particularly checked in with a published seat number), there can be carried out a search procedure for a better seat if desired, by the steps of allocation according to the invention. In this connection, there is guaranteed to the customer a minimum satisfaction by the seat which is already assigned and a search is carried out for a better seat.

For the procedure according to the invention, there will be used particularly computer means for its practice. These means comprise data storage means and particularly a computer database as well as processing means in the form of a processor.

In the first instance, we proceed to the definition of the group of seats available, to which will be applied the allocation process. This group of available seats is defined by subtraction from all the seats of the airplane the seats considered as unavailable including those for which the reservation is confirmed. Other seats can also be considered as unavailable for other reasons, in particular if they cannot be used in the course of a flight.

There is assigned moreover, in the database, to each customer, a level of priority. There can be used as priority level the different levels of classes used at present in aircraft transport, such as business class and economy class. However, any other type of classification can be used to refine the computation.

The database also comprise, for each customer, data relative to criteria of placement.

There will be given hereafter various examples of placement criteria which could be used:
1—Region of the aircraft in which the passenger with a certain level of priority should be placed,
2—Particular seat appropriate for the passenger,
3—Criteria of adjacency or relation with other passengers: according to this criterion, it is possible to carry out an allocation by respecting a placement adjacent one or several other passengers in the aircraft. There could also be defined different levels of respect of this adjacency criterion. In particular, it can be only preferential or, on the contrary, mandatory.
4—Criterion of multi-leg flight: in certain cases, connections are necessary between several legs of the same flight. In this connection, a criterion of particular placement in the aircraft could be considered, particularly to ensure the availability of a seat for a passenger within the scope of a connecting flight.
5—Criteria of distribution of the weight in the cabin: this criterion is necessary to ensure good distribution of the weight in the aircraft and to ensure the safety of the transportation.
6—Additional criterion of comfort: this criterion is particularly usable for passengers of a high level of priority.

By way of example, it can be a matter of additional services which could give satisfaction, like the preservation of free seats about the passenger.

The placement criteria of which examples have been given above can have different levels of importance and the calculation will thus be more difficult as a result. In particular, certain criteria can be absolutely necessary, others of minor importance, or others of medium importance. There is thus given to each criterion a particular weight.

There is given hereafter a particular example of the practice of the invention.

TABLE 1

| Delivered | Status of | Manual | | |
|---|---|---|---|---|
| seat | customer | indicator of | | Allocation |
| product | seats | assignment | Example | possible |
| None | Not | No | Not | Yes |
| | guaranteed | | available | |
| Having a | Not | No | NSST HN | Yes |
| preference | guaranteed | | | |
| Having a | Not | No | 12A HN | Yes |
| seat no. | guaranteed | | | |
| Preference | Guaranteed | No | NSST HK | Yes |
| confirmed | | | | |
| Seat no. | Guaranteed | Yes | 12A HK | Yes |
| confirmed | | | | |
| Indication | | | | |
| of manual | | | | |
| assignment | | | | |
| Seat no. | Guaranteed | No | 12A HK | No |
| confirmed | | | | |
| Having a | Refused | No | NSST HN | No |
| preference | | | | |
| Having a | Refused | No | 12A HN | No |
| seat no. | | | | |
| None | Refused | No | Not | No |
| | | | available | |

The above table gives various possibilities of characteristics of allocation of seats to customers.

The customers with a “rejected” status will not be taken into account in the allocation procedure.

The procedure automatically includes any customer to which a seat has been allotted but who is not satisfied with it and has not been confirmed.

Moreover, for customers who have a seat already confirmed, an allocation procedure according to the invention remains possible for seeking a possibly better seat. The assignment “Manual assignment indicator” is then placed at “Yes”.

TABLE 2

| Characteristic | Value | Description |
|---|---|---|
| Sellable capacity | 100 | |
| Agreement of | −8 | Agreement of |
| reservation space | | distribution of space |
| | | with an AA carrier |
| Dead loading | −10 | Reduced capacity of 10 |
| restriction | | seats because the |
| | | aircraft does not have |
| | | enough fuel for its |
| | | flight |
| No passenger in | −1 | Loading and transit |
| transit | | |
| Broken seat | −1 | A seat is unusable. |
| Number of confirmed | −18 | |
| seats | | |
| Confirmed preferences | −7 | |
| Seats reserved for | −2 | Theoretical seats |
| passengers with | | reserved for 2 |
| special business | | particular passengers |
| | | (for example |
| | | wheelchairs) |
| Seats reserved (ZZ | −6 | Seats reserved for a |
| PNRs) | | wounded passenger |
| Protected seats | −6 | Protected seats for |
| | | the placement of a |
| | | cradle |
| Rest seats for the | −6 | Seats reserved for the |
| crew | | crew |
| Protected seats | −2 | |
| because of reservation | | |
| of certain sections of | | |
| a multi-section flight | | |
| Subtotal | −67 | |
| Remaining capacity | | |
| Total | 100 − 67 = 33 | |

Table 2 gives an example of determination of the group of seats available for allocation. It shows various cases of unavailability of seats.

In the last analysis, of 100 seats, only 33 seats remain in the group of seats available for allocation.

If for example 40 customers must take part in an allocation, the allocation server will attribute the 33 available seats to the 33 passengers who have the highest level of priority. The 7 others will not have seats allocated and will be placed on the waiting list.

By way of indication, two examples follow as to the weight given to each criterion to be taken into account.

Example of weighting the criteria of placement in first class:
Region of the aircraft: 20%
Most suitable seat: 80%
Desire expressed by the passenger: 90%
Criterion of adjacency: 15%
Criterion of distribution of mass: 10%
Additional comfort criteria (courtesy seat): 60%

In this example, the process of allocation of seats will give priority to the following placement criteria:
desired expressed by the passenger (90%): the process of allocation will make all the decisions necessary for the satisfaction of the desires of the passengers,
the most suitable seat (80%): the process of allocation will attribute to the passengers the seats that are the nearest the desired passengers,
additional comfort criteria (courtesy seat) (60%): the process of allocation will seek to keep empty the seats beside passengers having the highest rank.

Other placement criteria will be considered as less important:
criteria of weight distribution (10%): the first class conventionally represents a small portion of the aircraft and the criterion of distribution of the masses is not the key to the allocation process.
Adjacency criteria (15%): most of the travelers in first class are business people having no need to be side by side (like family could be in economy class).

Here then is an example of the weight of the criteria of placement in economy class:
Region of the aircraft: 80%
The most suitable seat: 30%
Desire expressed by the passener: 50%
Criteria of adjacency: 70%
Criteria of weight distribution: 10%
Addition comfort criteria (courtesy seat): 5%

In this example, the process of allocation of the seats will favor the following placement criteria:
zone of the aircraft (80%) : the allocation process will assign the seats principally taking account of their category. For example, minors traveling alone will have seats in the same region of the aircraft (rear of the cabin). The passengers traveling regularly will be seated in the front of the cabin.
criterion of adjacency (70%): a large number of groups and families travel in economy class and need seats side by side.

The process of allocation of seats to customers calculates, for each passenger, a number of possible seats and classifies them. For example, the passenger DUPONT could have assigned to him four seats:
12A: rank 95%→satisfies all the criteria of placement (the passenger desires a window and seat 12A is located next to a window). This is a very good seat for the DUPONT passenger.
14B: rank 80%→satisfies a portion of the placement criteria. It's a good seat for the DUPONT passenger.
20E: rank 20% . . .
34F: rank 12% . . .

The process of allocation of seats to these customers takes into account all the seats possible for each passenger and seeks for a match: DUPONT will have seat 14B, DURANT will have seat 21A etc. . . . so as to maximize the satisfaction of the passengers of the aircraft.

1-10. (canceled)

11. Computer program product for the allocation of seats to customers in a computerized reservation system, characterized by the fact
that it comprises allocation instructions for, when it is executed by a computer:
accessing a database of storage of data relative to placement criteria;
extracting from said database the data corresponding to each customer;
determining a satisfaction value of the customer for a seat, said satisfaction value being a function of the agreement with the placement criteria;
accessing with a database for storage of a level of priority assigned to each customer;
extracting from each database the level of priority corresponding to each customer;
for the customer having the highest level of priority, seeking the available seat having the highest satisfaction value and storing an identification data of said seat in a data table assigned to the customers;
repetition of the preceding step for each customer, by decreasing order of priority level, to effect an allocation of seats to the customers.

12. Product according to claim 11 comprising instructions to repeat the allocation instruction steps at each new reservation or cancellation of a seat.

13. Product according to claim 11 comprising instructions to create a waiting list defined by the customers remaining after assignment of all the available seats.

14. Product according to claim 11 comprising instructions to assign to each seat an inclusion attribute in the group of available seats so as to define the seats available for allocation.

15. Product according to claim 14 comprising instructions to exclude from the group of available seats the seats whose reservation has been confirmed by the customer.

16. Product according to claim 15 comprising instructions to repeat the allocation instruction steps for customers whose seat has a confirmed reservation to seek a possible better seat.

17. Product according to claim 11 characterized by the fact
that the placement criteria comprise data as to region or location of the seats desired by the customer.

18. Product according to claims 11 characterized by the fact that
the placement criteria comprise an adjacency criterion of the customer to at least one other customer.

19. Product according to claim 11 characterized by the fact
that it comprises instructions to assign to each placement criterion an attribute defining it either as mandatory or as preferred.

20. Product according to claim 11 characterized by the fact
that it comprises instructions to assign to each placement criterion an attribute of weight for the determination of the satisfaction values.

21. Process for the allocation of seats to customers, usable with a computerized reservation system, characterized by the fact
that it comprises the following allocation steps:
assignment, in a database, to each customer, of data relative to placement criteria;
determination of a value of satisfaction of the customer for a seat as a function of agreement with the placement criteria,
assignment, in a database, to each customer, of a priority level,
allocation by an allocation server, to each customer, by decreasing order of level of priority, of the available seat having the maximum satisfaction value.

22. Process according to claim 21, characterized by the fact
that the steps of allocation are repeated upon each new reservation or cancellation of a seat.

23. Process according to claim 21, characterized by the fact that
if the available seats are all assigned, placement of the remaining customers on the waiting list.

24. Process according to claim 21, characterized by the fact
there is assigned to each seat at least one attribute of inclusion in the group of available seats, for the definition of the seats available for allocation.

25. Process according to claim 24, characterized by the fact
that there is excluded from the group of available seats, the seats whose reservation is confirmed by the customer.

26. Process according to claim 25, characterized by the fact that
for customers whose seat has a confirmed reservation, there is carried out a search procedure for a possible better seat by the steps of allocation.

27. Process according to claim 21, characterized by the fact that
the placement criteria comprise data as to zone or location of the seats desired by the customer.

28. Process according to claim 21, characterized by the fact that the placement criteria comprise a criterion of adjacency of the customer to at least one other customer.

29. Process according to claim 21, characterized by the fact
that there is assigned to each placement criterion an attribute defining it either as mandatory or as preferred.

30. Process according to claim 21, characterized by the fact
that there is assigned to each placement criterion an attribute of weight for the determination of satisfaction values.
